(19) United States
(12) Patent Application Publication
(10) Pub. No.: US 2026/0065070 A1
(43) Pub. Date: Mar. 5, 2026

(54) ARTIFICIAL INTELLIGENCE-BASED DEVICE STORAGE SYSTEM WITH DATA STRUCTURE PROCESSING

(71) Applicant: Dell Products L.P., Round Rock, TX (US)

(72) Inventors: Mubashir Ul Haq, Austin, TX (US); Bijan Kumar Mohanty, Austin, TX (US); Gregory Michael Ramsey, Seattle, WA (US); Hung T. Dinh, Austin, TX (US)

(21) Appl. No.: 18/819,357

(22) Filed: Aug. 29, 2024

(51) Int. Cl. G06N 3/096; G06N 3/0475

(52) U.S. Cl. CPC G06N 3/096; G06N 3/0475

(57) ABSTRACT

Methods, apparatus, and processor-readable storage media for an artificial intelligence-based device storage system with data structure processing are provided herein. An example computer-implemented method includes processing input data into one or more data structures, the input data related to storing at least one device for at least one user; predicting at least one duration of storage of the device(s) for the user(s) by processing at least portions of the data structure(s) using one or more machine learning techniques; predicting a likelihood of storing the device(s) beyond the predicted duration(s) of storage by processing at least portions of the data structure(s) using the machine learning technique(s); and performing one or more automated actions based on one or more of the predicted duration(s) of storage and the predicted likelihood of storing the device(s) beyond the predicted duration(s) of storage.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

In certain instances, users seek storage of manufactured devices until the users are ready to deploy the devices. However, using conventional device storage approaches, challenges with such arrangements exist. For example, at the end of a storage term, the users may not be ready to retrieve and deploy the devices, rendering such approaches resource-intensive, error-prone and unpredictable for the storage entity.

### SUMMARY

Illustrative embodiments of the disclosure provide an artificial intelligence-based device storage system with data structure processing.

An exemplary computer-implemented method includes processing input data into one or more data structures, the input data related to storing at least one device for at least one user, and predicting at least one duration of storage of the at least one device for the at least one user by processing at least portions of the one or more data structures using one or more machine learning techniques. The method also includes predicting a likelihood of storing the at least one device beyond the at least one predicted duration of storage by processing at least portions of the one or more data structures using the one or more machine learning techniques. Further, the method includes performing one or more automated actions based at least in part on one or more of the at least one predicted duration of storage and the predicted likelihood of storing the at least one device beyond the at least one predicted duration of storage.

Illustrative embodiments can provide significant advantages relative to conventional device storage approaches. For example, problems associated with resource-intensive, error-prone and unpredictable techniques are overcome in one or more embodiments through automatically predicting a storage duration for a given device for a given user, and automatically predicting the likelihood of the given user storing the given device beyond the storage duration.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for artificial intelligence-based device storage management with machine learning-based processing of data structures in an illustrative embodiment.

FIG. 2 shows example architecture of a multi-output neural network in an illustrative embodiment.

FIG. 3 shows example pseudocode for data preprocessing in an illustrative embodiment.

FIG. 4 shows example pseudocode for encoding categorical values into numerical values in an illustrative embodiment.

FIG. 5 shows example pseudocode for splitting and scaling data in an illustrative embodiment.

FIG. 6 shows example pseudocode for creating a neural network model in an illustrative embodiment.

FIG. 7 shows example pseudocode for training and evaluating a neural network model in an illustrative embodiment.

FIG. 8 shows example architecture of at least a portion of machine learning-based device storage prediction engine in an illustrative embodiment.

FIG. 9 shows example pseudocode for preparing a dataframe for use with a random forest classifier model in an illustrative embodiment.

FIG. 10 shows example pseudocode for processing data to be used with a random forest classifier model in an illustrative embodiment.

FIG. 11 shows example pseudocode for splitting training and testing datasets in an illustrative embodiment.

FIG. 12 shows example pseudocode for training and evaluating a random forest classifier model in an illustrative embodiment.

FIG. 13 shows example pseudocode for generating predictions using a trained random forest classifier model in an illustrative embodiment.

FIG. 14 is a flow diagram of a process for artificial intelligence-based device storage management with machine learning-based processing of data structures in an illustrative embodiment.

FIGS. 15 and 16 show examples of processing platforms that may be utilized to implement at least a portion of an information processing system in illustrative embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

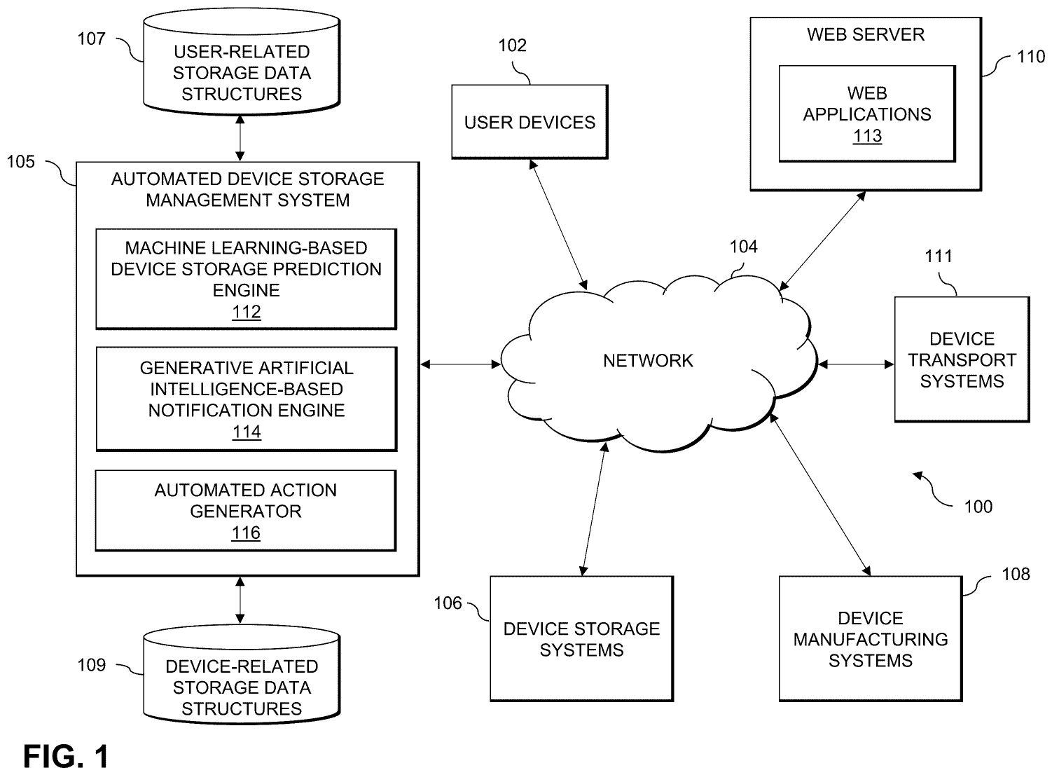

FIG. 1 shows a computer network (also referred to herein as an information processing system) 100 configured in accordance with an illustrative embodiment. The computer network 100 comprises one or more user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks” but the latter is assumed to be a component of the former in the context of the FIG. 1 embodiment. Also coupled to network 104 is automated device storage management system 105, one or more web applications 113 (e.g., e-commerce applications, device support applications, etc.) executing on web server 110, one or more device storage systems 106, one or more device manufacturing systems 108, and one or more device transport systems 111.

The user devices 102 may comprise, for example, mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, the automated device storage management system 105 can have one or more associated user-related storage data structures 107 configured to store data pertaining to multiple users and historical device storage data related thereto (e.g., user geographic information, storage durations for various devices associated with multiple users, storage term violations associated with multiple users, etc.). Also, as depicted in FIG. 1, the automated device storage management system 105 can have one or more associated device-related storage data structures 109 configured to store data pertaining to multiple devices and storage information related thereto (e.g., device manufacturing information, device storage locations, device quantity information, device storage cost information, etc.). The term “data structure,” as used herein, is intended to be broadly construed, so as to encompass, for example, a wide variety of different types of tables, arrays, graphs, trees, linked lists, and additional or alternative data relation mechanisms, as well as portions or combinations thereof. Accordingly, a given data structure can comprise a combination of multiple smaller data structures, possibly of different types, or a portion of a larger data structure. Numerous other arrangements are possible.

The user-related storage data structures 107 and/or device-related storage data structures 109 in the present embodiment are implemented using one or more storage systems associated with the automated device storage management system 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with the automated device storage management system 105 are one or more input-output devices, which illustratively comprise keyboards, displays or other types of input-output devices in any combination. Such input-output devices can be used, for example, to support one or more user interfaces to the automated device storage management system 105, as well as to support communication between the automated device storage management system 105 and other related systems and devices not explicitly shown.

Additionally, the automated device storage management system 105 in the FIG. 1 embodiment is assumed to be implemented using at least one processing device. Each such processing device generally comprises at least one processor and an associated memory, and implements one or more functional modules for controlling certain features of the automated device storage management system 105.

More particularly, the automated device storage management system 105 in this embodiment can comprise a processor coupled to a memory and a network interface.

The processor illustratively comprises a microprocessor, a central processing unit (CPU), a graphics processing unit (GPU), a tensor processing unit (TPU), a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the automated device storage management system 105 to communicate over the network 104 with the user devices 102, and illustratively comprises one or more conventional transceivers.

The automated device storage management system 105 further comprises a machine learning-based device storage prediction engine 112, a generative artificial intelligence-based notification engine 114, and an automated action generator 116.

It is to be appreciated that this particular arrangement of elements 112, 114 and 116 illustrated in the automated device storage management system 105 of the FIG. 1 embodiment is presented by way of example only, and alternative arrangements can be used in other embodiments. For example, the functionality associated with elements 112, 114 and 116 in other embodiments can be combined into a single module, or separated across a larger number of modules. As another example, multiple distinct processors can be used to implement different ones of elements 112, 114 and 116 or portions thereof.

At least portions of elements 112, 114 and 116 may be implemented at least in part in the form of software that is stored in memory and executed by a processor.

It is to be understood that the particular set of elements shown in FIG. 1 for artificial intelligence-based device storage management with machine learning-based processing of data structures involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, two or more of automated device storage management system 105, user-related storage data structures 107, device-related storage data structures 109, and web server 110 can be on and/or part of the same processing platform.

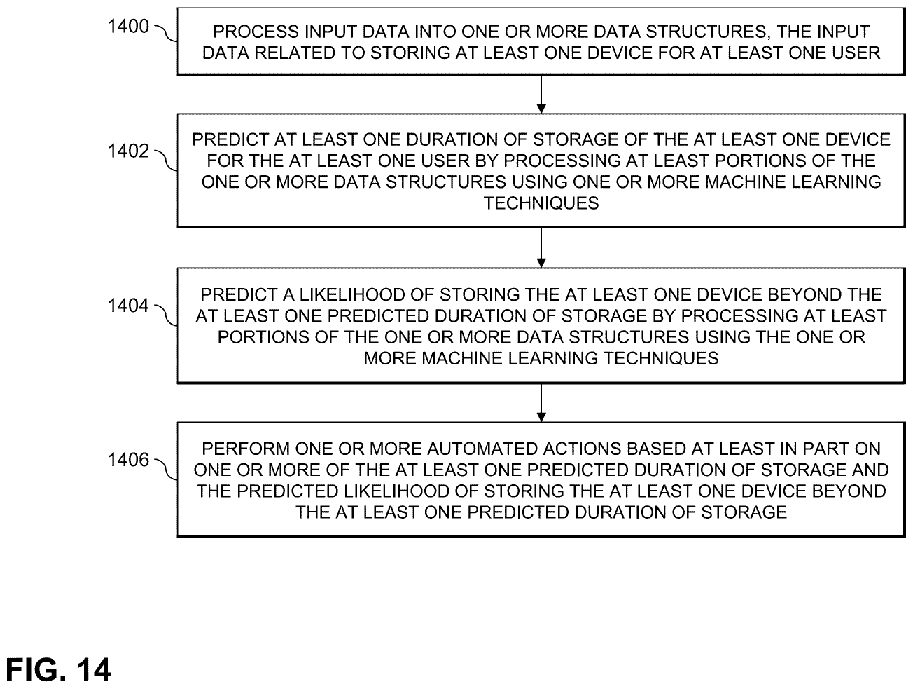

An exemplary process utilizing elements 112, 114 and 116 of an example automated device storage management system 105 in computer network 100 will be described in more detail with reference to the flow diagram of FIG. 14.

Accordingly, at least one embodiment includes enhancing device storage management using one or more artificial intelligence-based predictive models. As further detailed herein, such an embodiment includes dynamically determining appropriate storage durations for different devices, wherein such a determination is influenced by multiple factors, including, for example, user identity, user location, storage location, type of device, seasonality, etc. Additionally, based at least in part on determining appropriate storage durations for particular devices, one or more embodiments can also include proactively predicting term violations by users. Further, based at least in part on the identified and/or predicted term violations, at least one embodiment can include enabling automated notifications to corresponding users, prompting the users to expedite the retrieval of particular devices and/or preemptively extend the storage terms in question.

As detailed herein, one or more embodiments include predicting an appropriate duration of the storage for a given device in connection with a given user, as well as predicting the likelihood of storing the given device beyond the predicted duration. Such an embodiment can include using one or more machine learning techniques trained on historical device storage data, device-related data and/or user-related data. In addition, at least one embodiment includes using generative artificial intelligence techniques to generate notification content (e.g., email content) and send portions of such notification content to users in connection with the need for user action with respect to a given stored device.

In one or more embodiments, machine learning techniques are trained using historical data related to devices and users, analyzing, e.g., device storage durations, statuses, etc. By predicting how long a device will be stored and whether the device storage will exceed a given storage term (e.g., a designated and/or purchased term between the user and the storage entity), such an embodiment can include enabling the determination of enhanced storage terms and facilitating automated processes around notification and resource-utilization when a given device storage exceeds a corresponding storage term.

As further detailed herein, one or more embodiments include implementing at least one multi-output neural network, specifically configured with dual branches to function both as a regressor and a classifier. In such an embodiment, the at least one multi-output neural network is used to predict (e.g., via regression) the duration of storage of a given device for a given user, and to determine (e.g., via classification) the likelihood of one or more storage term violations by the given user. Also, in at least one embodiment, such a neural network is trained using one or more historical datasets which incorporate multi-dimensional features such as, e.g., the type and quantity of devices stored, user details, geographic locations with respect to users and storage facilities, one or more seasonal factors, etc. By way of example, seasonal factors can be captured by the date of purchase, storage, and/or shipping. Unlike rules systems, neural networks and/or other statistical algorithms do not necessarily need to capture specific seasonality information such as, e.g., shopping, holidays, enterprise budgets, etc. As long as the features (e.g., purchase dates, storage data, order date selection for shipping, etc.) are captured, the algorithm can learn the seasonality factors from the corresponding data.

To prepare for and/or sufficiently train such a neural network, one or more embodiments include carrying out a data engineering process to harvest and refine data from one or more data structures. Data variables such as, e.g., device type, user demographics, user location, storage location, device quantity, temporal factors, etc., can be identified and extracted from at least a portion of the one or more data structures, and subsequently processed to create at least one refined dataset. The at least one dataset can then be preserved and/or stored within at least one data structure (e.g., within a portion of the above-noted one or more data structures and/or within at least one distinct and/or separate data structure), serving as an asset for future and/or ongoing training and/or analytical assessment. For example, the dataset stored in the at least one data structure can be used to train at least one deep learning-based multi-output neural network model, enhancing its predictive accuracy with respect to device storage duration and potential user term violations.

More particularly, such a neural network model can include a classification model that can evaluate a given device against a corresponding storage term duration, predicting whether the device will remain unclaimed by end of the storage term based at least in part on the temporal assessments. In one or more embodiments, such predictive capability can be operationalized through scheduled jobs that identify devices at risk of exceeding their storage terms within a given temporal period (e.g., within the forthcoming one to two months). Also, such predictions can trigger one or more generative artificial intelligence techniques to autonomously generate and dispatch notifications (e.g., emails, text messages, etc.) to relevant users, urging the users to retrieve the corresponding devices and/or extend the corresponding device storage agreements.

Referring again to FIG. 1, one or more embodiments includes implementing user-related storage data structures 107 and device-related storage data structures 109, machine learning-based device storage prediction engine 112, and generative artificial intelligence-based notification engine 114.

In such an embodiment, at least portions of the data stored in user-related storage data structures 107 and device-related storage data structures 109 can be used for training machine learning-based device storage prediction engine 112 (e.g., a multi-output neural network within machine learning-based device storage prediction engine 112). Additionally, in one or more embodiments, data engineering and/or data analysis can be carried out on portions of the data stored in user-related storage data structures 107 and device-related storage data structures 109 to learn and/or understand one or more data elements that influence the target values (e.g., predicted storage time as well as the likelihood of term violation) such that those data elements are filtered for storage. The data elements can include, for example, relevant features including dates and other temporal information, user identifying information, device identifying information, device quantities, device type and/or class, geographical locations of the user and/or storage facilities, historical storage durations for one or more devices and/or one or more users, storage term violation information, etc.

In at least one embodiment, the machine learning-based device storage prediction engine 112 is responsible for predicting an estimated device storage duration time for a given device in connection with a given user, as well as for predicting the probability and/or likelihood of the given user violating the storage term (e.g., the predicted estimated device storage duration time for the given device). By way merely of example, such predictions can be used by a sales system to add the appropriate warehouse storage offer term to optimize the term with the actual duration of the device storage by the user purchasing the device.

Additionally, in a field support context, the machine learning-based device storage prediction engine 112 can leverage at least one supervised learning mechanism and train a model with historical data containing actual support duration temporal data for each of a given set of users. Important features extracted from such historical data can include, e.g., the device being supported, the type of support, parts being replaced, field engineer information, if the support call in question is a return trip to the location for unfinished work from a previous visit, etc. During training, such features are fed to the model as the independent variable and the actual support time data in the historical data is fed to the model as the dependent/target value. While scheduling a field service dispatch with a given user, the trained model in machine learning-based device storage prediction engine 112 is used to predict the estimated support duration time which will enable an appropriate duration for the engineer to provide the device support.

As further detailed herein, in one or more embodiments, machine learning-based device storage prediction engine 112 utilizes at least one deep neural network by building a dense, multi-layer neural network which can act as a sophisticated regressor.

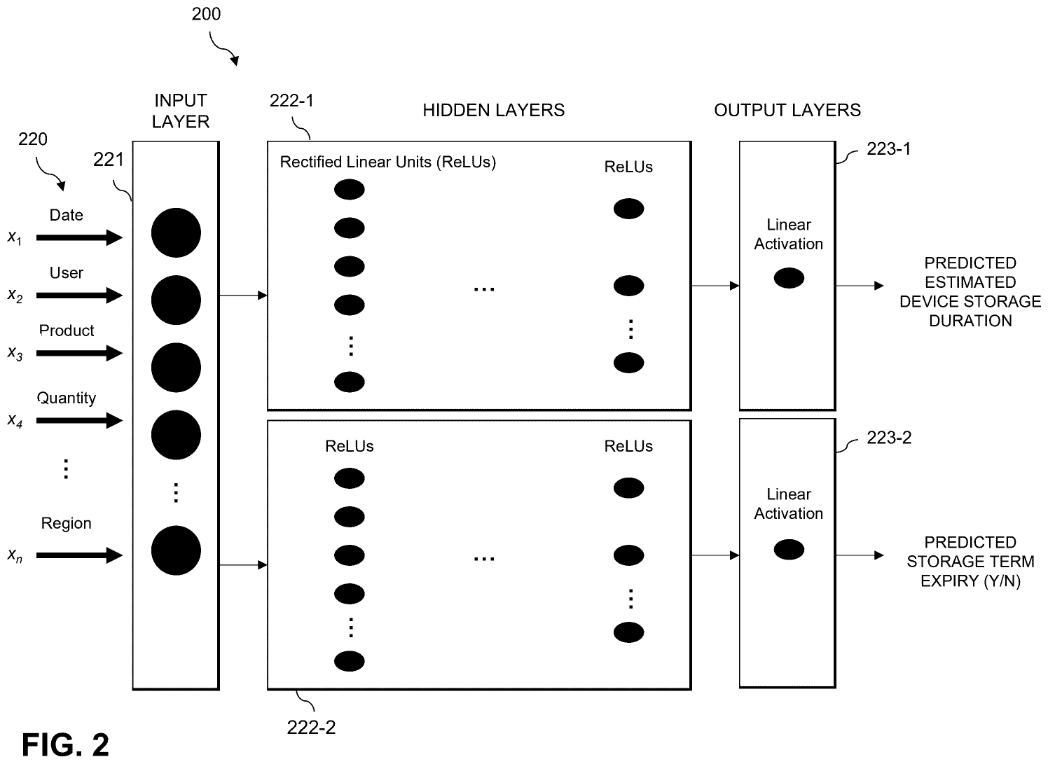

FIG. 2 shows example architecture of a multi-output neural network 200 in an illustrative embodiment. By way of illustration, FIG. 2 depicts multi-output neural network 200, which includes an input layer 221, hidden layers 222-1 and 222-2, and output layers 223-1 and 223-2. Input layer 221 includes a number of neurons that matches the number of input/independent variables 220. In the example embodiment depicted in FIG. 2, the input/independent variables 220 include date (x₁), user (x₂), product (x₃), quantity (x₄), . . . , region (xₙ). In hidden layers 222-1 and 222-2, the number of neurons on each layer is based at least in part on the number of neurons in the input layer 221. Also, output layers 223-1 and 223-2 each contain a single neuron, as multi-output neural network 200 serves at least in part as a regression model.

Referring again to hidden layers 222-1 and 222-2, while FIG. 2 depicts five neurons in the first hidden layer and three neurons in the second hidden layer, the actual values can depend upon the total number of neurons in the input layer 221. Also, the neurons in hidden layers 222-1 and 222-2 and output layers 223-1 and 223-2 contain at least one activation function which drives and/or determines whether the neuron will fire or not. As depicted in the example architecture of FIG. 2, a rectified linear unit (ReLU) activation function is used in both of hidden layers 222-1 and 222-2. Considering that the multi-output neural network 200 is being architected to behave as a regressor and a classifier, the output layer neurons will contain a linear activation function for output layer (regressor) 223-1 and a Sigmoid activation function for output layer (classifier) 223-2.

Considering that multi-output neural network 200 is a dense neural network, each neuron will connect with each other neuron. Each connection will have a weight factor and the neurons will have a bias factor. These weight and bias values, in one or more embodiments, can be set randomly by the multi-output neural network 200, and such designations can be set, e.g., as one or zero for all values. In at least one embodiment, each neuron performs a linear calculation by combining the multiplication of each input variable with their weight factor, and then adding the bias value of the neuron. The formula for this calculation is shown as follows:

$${ws}_{1} = {x}_{1} * {w}_{1} + {x}_{2} * {w}_{2} + … + {b}_{1}$$

wherein ws₁ represents the weighted sum of neuron1, x₁, x₂, etc. represent the input values to the neural network model, w₁, w₂, etc. represent the weight values applied to the connections to neuron1, and b₁ represents the bias value of neuron1. This weighted sum is input to an activation function (e.g., ReLU) to compute the value of the activation function. Similarly, the weighted sum and activation function values of all other neurons in the given layer are calculated, and these values are fed to the neuron(s) of the next layer. Additionally, the same process is repeated in the next layer's neuron(s) until the values are fed to the neurons of the output layers, where the weighted sum is also calculated and compared to the actual target value(s). Based at least in part on the difference, a loss value is calculated, and this pass-through of the neural network is referred to as a forward propagation which calculates the loss value and drives a backpropagation through the neural network to minimize the loss at each neuron of the neural network. Considering that the loss is generated by all of the neurons in the neural network, backpropagation goes through each layer, from back to front, and attempts to reduce and/or minimize the loss by using at least one gradient descent-based optimization mechanism. Also, because the multi-output neural network 200 is used as a regressor and classifier, the loss function of “mean_squared_error” can be used for the regressor and the loss function of “binary_crossentropy” can be used for the classifier (e.g., for the binary classification to predict term expiry), and adaptive moment estimation (Adam) can be used as the optimization algorithm for both output layer branches.

The result of such a backpropagation as detailed above can include adjusting the weight values and/or the bias values at each connection and neuron level to reduce the loss. Further, once the training data are passed through the multi-output neural network 200, an epoch is completed. Another forward propagation is initiated with the adjusted weight and bias values, which are considered as epoch2, and the same process of forward and backpropagation is repeated in the subsequent epoch(s). This process of repeating the epochs results in the reduction of the loss value to a small number (e.g., close to zero), at which point the multi-output neural network 200 is considered to be sufficiently trained for prediction.

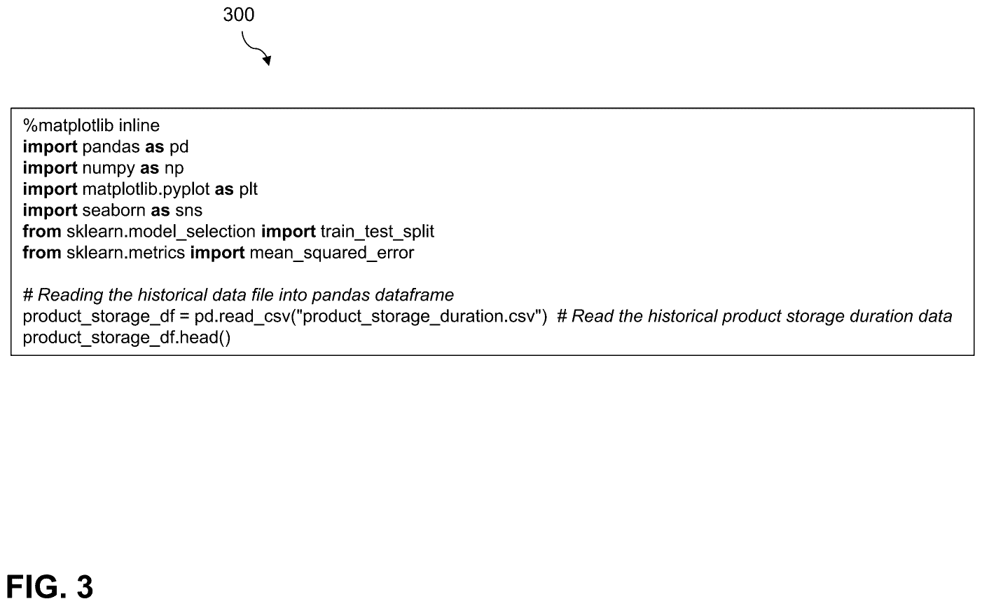

The implementation of portions of the techniques detailed herein in connection with machine learning-based device storage prediction engine 112 can be achieved, for example, as depicted in the example pseudocode in FIG. 3 through FIG. 7, by using Keras with a Tensorflow backend, Python language, as well as Pandas, Numpy and ScikitLearn libraries.

FIG. 3 shows example pseudocode for data preprocessing in an illustrative embodiment. In this embodiment, example pseudocode 300 is executed by or under the control of at least one processing system and/or device. For example, the example pseudocode 300 may be viewed as comprising a portion of a software implementation of at least part of automated device storage management system 105 of the FIG. 1 embodiment.

The example pseudocode 300 illustrates importing libraries and functions, as well as reading at least one historical dataset from at least one data structure (e.g., user-related storage data structures 107 and device-related storage data structures 109 in the FIG. 1 embodiment). Additionally, a Pandas dataframe is generated based at least in part on the at least one historical dataset, wherein the dataframe contains independent variable columns and the dependent/target variable column. As part of preprocessing data in the dataframe, one step includes handling any null or missing values in the columns. For example, null or missing values in numerical columns can be replaced by the median value of that column. After performing initial data analysis by creating one or more univariate and/or bivariate plots of the columns, the importance and/or influence of each column can be determined and/or understood. Columns which have limited or no importance and/or influence on the actual storage duration or term expiry probability (i.e., the target variable) can be dropped.

It is to be appreciated that this particular example pseudocode shows just one example implementation of data preprocessing, and alternative implementations can be used in other embodiments.

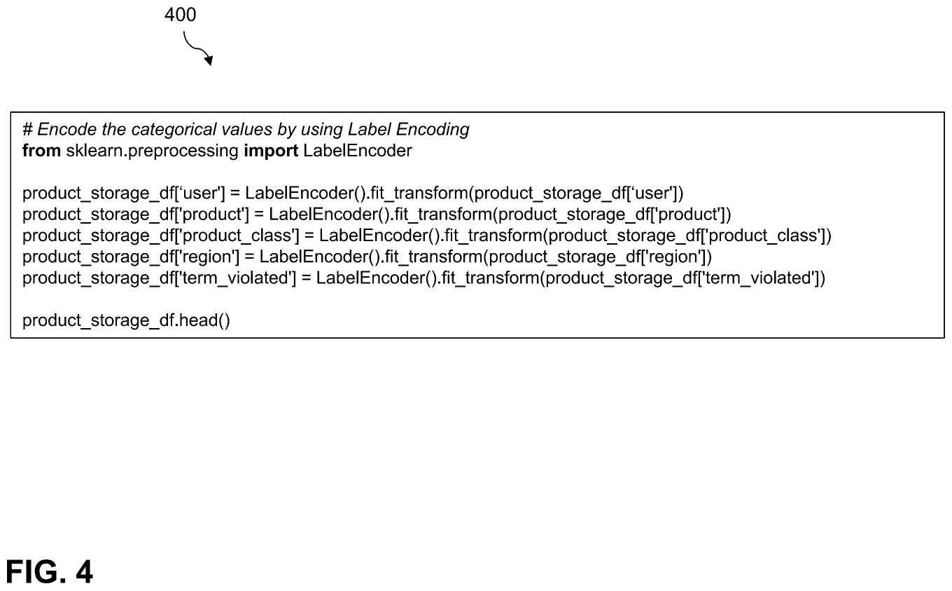

FIG. 4 shows example pseudocode for encoding categorical values into numerical values in an illustrative embodiment. In this embodiment, example pseudocode 400 is executed by or under the control of at least one processing system and/or device. For example, the example pseudocode 400 may be viewed as comprising a portion of a software implementation of at least part of automated device storage management system 105 of the FIG. 1 embodiment.

In connection with example pseudocode 400, as machine learning models process numerical values, textual categorical values in the columns must be encoded. For example, data pertaining to user identifying information, device identifying information, device class information, etc. can be encoded, and such encoding, can be achieved by using one-hot encoding, dummy variable encoding (e.g., a get_dummies function of pandas), and/or a LabelEncoder function, as illustrated in example pseudocode 400.

It is to be appreciated that this particular example pseudocode shows just one example implementation of encoding categorical values into numerical values, and alternative implementations can be used in other embodiments.

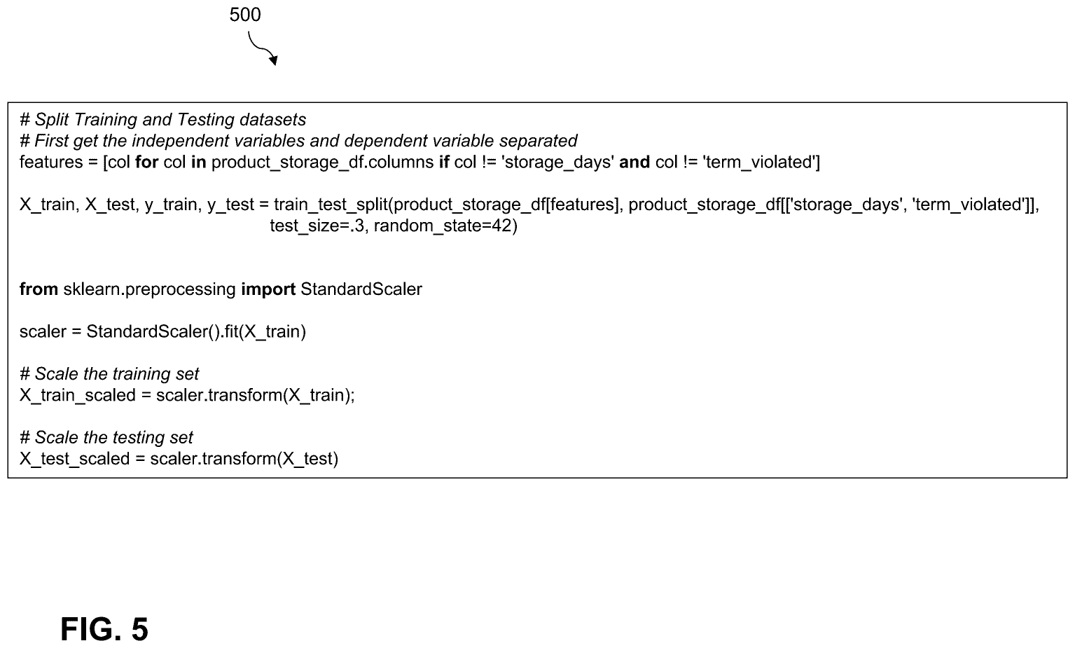

FIG. 5 shows example pseudocode for splitting and scaling data in an illustrative embodiment. In this embodiment, example pseudocode 500 is executed by or under the control of at least one processing system and/or device. For example, the example pseudocode 500 may be viewed as comprising a portion of a software implementation of at least part of automated device storage management system 105 of the FIG. 1 embodiment.

The example pseudocode 500 illustrates splitting a preprocessed dataset into training and testing sets using a train_test_split function of a ScikitLearn library (e.g., with a 70% training data and 30% testing data split). Considering at least one embodiment includes a regression use case and a dense neural network will be used as the model, scaling the data before passing the data to the model can also be carried out. For example, the scaling can be performed after the training and testing split is performed, and the scaling can be achieved by passing the training data and the testing data to a StandardScaler function of a ScikitLearn library. At the end of such scaling, the data can be deemed ready for model training and/or testing.

It is to be appreciated that this particular example pseudocode shows just one example implementation of splitting and scaling data, and alternative implementations can be used in other embodiments.

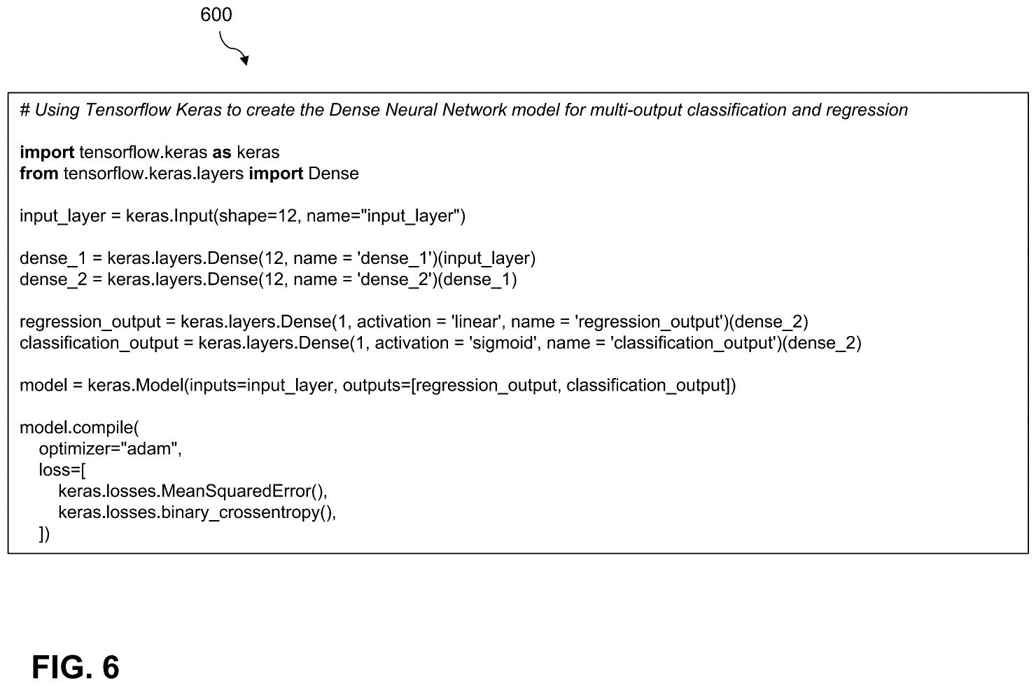

FIG. 6 shows example pseudocode for creating a neural network model in an illustrative embodiment. In this embodiment, example pseudocode 600 is executed by or under the control of at least one processing system and/or device. For example, the example pseudocode 600 may be viewed as comprising a portion of a software implementation of at least part of automated device storage management system 105 of the FIG. 1 embodiment.

The example pseudocode 600 illustrates creating a multi-layer, multi-output capable dense neural network using a Keras library. More particularly, the neural network is created using a Keras functional model, as two separate branches can be created and added to the functional model. The two separate dense layers are added to the input layer with each network capable of predicting different targets (e.g., storage duration in days and term expiry class (yes or no)). The neural network model can be configured to use, for example, Adam as the optimization function as well as MeanSquaredError and Binary_crossentropy as the error functions for regression and classification branches, respectively.

It is to be appreciated that this particular example pseudocode shows just one example implementation of creating a neural network model, and alternative implementations can be used in other embodiments.

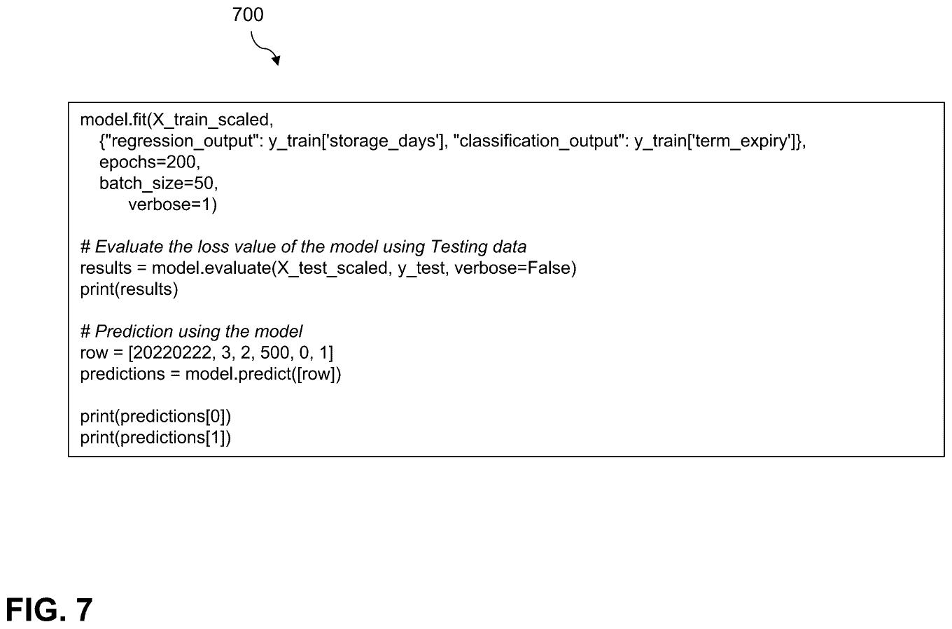

FIG. 7 shows example pseudocode for training and evaluating a neural network model in an illustrative embodiment. In this embodiment, example pseudocode 700 is executed by or under the control of at least one processing system and/or device. For example, the example pseudocode 700 may be viewed as comprising a portion of a software implementation of at least part of automated device storage management system 105 of the FIG. 1 embodiment.

The example pseudocode 700 illustrates training the neural network model by calling a fit( ) function of the model and passing the training data and a number of epochs. After the model completes the specified number of epochs, it is considered trained and ready for evaluation and/or validation. The loss value can be obtained by calling an evaluate( ) function of the model and passing the testing data. This loss value indicates how well the model is trained. For example, a higher loss value indicates that the model is not sufficiently trained, and hyperparameter tuning may be required. In one example, the number of epochs can be increased to further train the model. Other hyperparameter tuning can include changing the loss function, changing the optimizer algorithm, and/or making changes to the neural network architecture (e.g., by adding one or more hidden layers). Once the model is trained with a reasonable value of loss (e.g., close to zero), the neural network model is ready for prediction. Prediction of the model can be achieved by calling a predict( ) function of the model and passing the independent variables of the testing data (e.g., for comparing training versus testing data) or the input data that is to be processed for prediction (e.g., to estimate the expected storage duration time and the term expiration possibility as target variables).

It is to be appreciated that this particular example pseudocode shows just one example implementation of training and evaluating a neural network model, and alternative implementations can be used in other embodiments.

Referring again to FIG. 1, machine learning-based device storage prediction engine 112 is responsible for predicting if the device will be retrieved by the user on time or if the storage term limit of the device storage will be violated. In at least one embodiment, this includes dynamic risk prediction on whether the asset (e.g., the given device) will be shipped by the end of storage term or not based at least in part on how long the asset is in storage, the length of the term duration, as well as the asset type for the given user. In an example embodiment, such risk prediction can be carried out at the time of sale (of the given device by the given user), based at least in part on past history of the given user and the given device, and such dynamic prediction can also be carried out on a periodic basis post-sale and/or during device storage. In such an embodiment, upon generating a prediction that the given device will not be retrieved by the given user prior to the end of storage term, a notification can be generated by generative artificial intelligence-based notification engine 114 and automatically transmitted (e.g., using automated action generator 116) to the given user and/or one or more systems associated therewith, wherein such a notification can include at least one request and/or at least one recommendation related to a storage term upgrade, retrieval of the given device, etc.

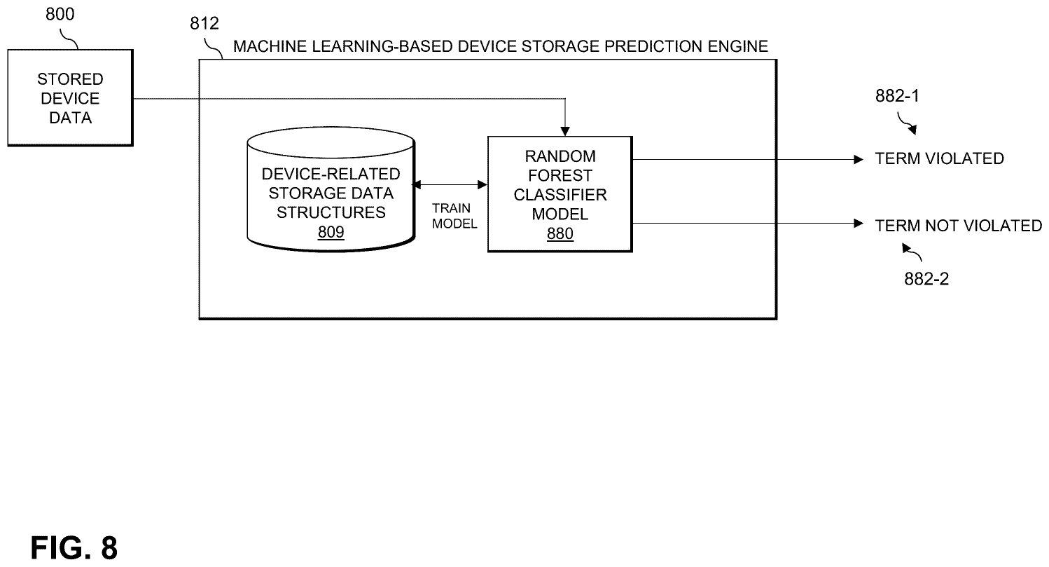

FIG. 8 shows example architecture of at least a portion of machine learning-based device storage prediction engine 812 in an illustrative embodiment. By way of illustration, FIG. 8 depicts historical device-related storage data, stored within at least portions of device-related storage data structures 809, for multiple users and multiple devices. Such data can include, for example, information pertaining to how long devices were stored, device storage term limits, device storage term violation information, etc. Such data can be used to train a random forest classifier model 880, within machine learning-based device storage prediction engine 812, to generate predictions regarding particular devices and storage parameters related thereto.

The random forest classifier model 880 uses bagging or bootstrap aggregating techniques to generate predictions. In one or more embodiments, this can include using multiple classifiers (e.g., in parallel), each trained on different data samples and/or different data features. This can reduce variance and bias which potentially stem from using a single classifier. In such an embodiment, the final classification is achieved by aggregating the predictions that were made by the different classifiers.

Also, in at least one embodiment, the random forest classifier model 880 is composed of multiple decision trees, wherein each decision tree is constructed using different features and different data samples, which reduces the bias and variance. In the training process, the decision trees are constructed using the training data, and in the testing process, each new prediction that needs to be made runs through the different decision trees, each decision tree yielding a score and the final prediction determined by voting (e.g., which class received the majority of votes). In such an embodiment, the random forest classifier model 880 processes stored device data 800 using multinomial and/or multi-class classification, meaning that the results of the classification are one of multiple types of classes. In the example embodiment depicted in FIG. 8, the multiple classes are class 882-1 (term violated) and class 882-2 (term not violated). Ultimately, the random forest classifier model 880 predicts one of the classes with a corresponding confidence score, and in such an embodiment, multiple independent variables (e.g., X values) can include the device type, device quantity, time in storage, term limit, time left on term, etc., whereas the target variable (Y value) is represented by class 882-1 and class 882-2.

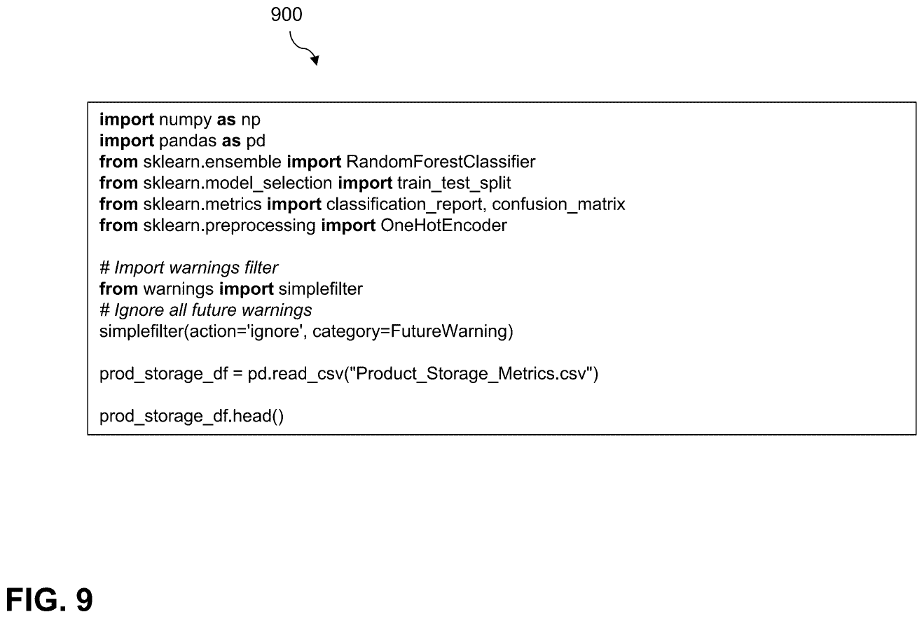

At least a portion of the random forest classifier model 880 can be built and/or implemented using ScikitLearn libraries with Python programming language, such as illustrated in the example pseudocode depicted in FIG. 9 through FIG. 13, to achieve classification to predict if the storage term of a stored device will be violated or not depending on the term limit as well as the time left in the term.

FIG. 9 shows example pseudocode for preparing a dataframe for use with a random forest classifier model in an illustrative embodiment. In this embodiment, example pseudocode 900 is executed by or under the control of at least one processing system and/or device. For example, the example pseudocode 900 may be viewed as comprising a portion of a software implementation of at least part of automated device storage management system 105 of the FIG. 1 embodiment.

The example pseudocode 900 illustrates importing libraries such as ScikitLearn, Pandas and Numpy, etc., and leveraging a product storage metrics file to create training data. More particularly, as depicted in example pseudocode 900, the data is created as a comma-separated values (CSV) file and read into a Pandas dataframe.

It is to be appreciated that this particular example pseudocode shows just one example implementation of a dataframe for use with a random forest classifier model, and alternative implementations can be used in other embodiments.

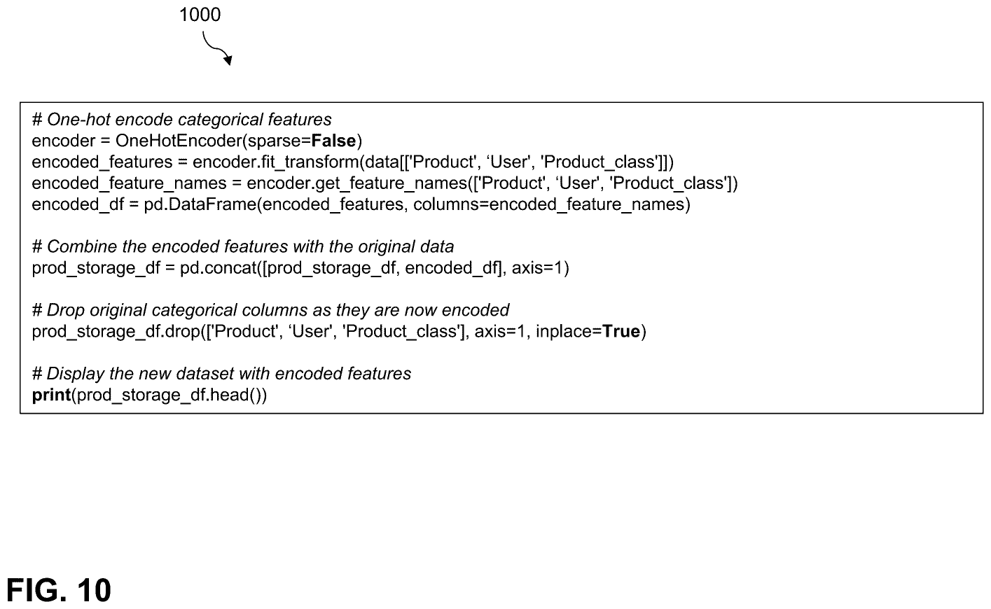

FIG. 10 shows example pseudocode for processing data to be used with a random forest classifier model in an illustrative embodiment. In this embodiment, example pseudocode 1000 is executed by or under the control of at least one processing system and/or device. For example, the example pseudocode 1000 may be viewed as comprising a portion of a software implementation of at least part of automated device storage management system 105 of the FIG. 1 embodiment.

In connection with example pseudocode 1000, as machine learning models (e.g., a random forest classifier model) work with numerical values, all categorical features are encoded using a one-hot encoder function of a ScikitLearn library. As also depicted by example pseudocode 1000, the encoded values can then be combined with at least a portion of the original data, the original categorical columns can be dropped and/or removed (as those values are now encoded), and the new dataset (with encoded features) can be output and/or displayed.

It is to be appreciated that this particular example pseudocode shows just one example implementation of processing data to be used with a random forest classifier model, and alternative implementations can be used in other embodiments.

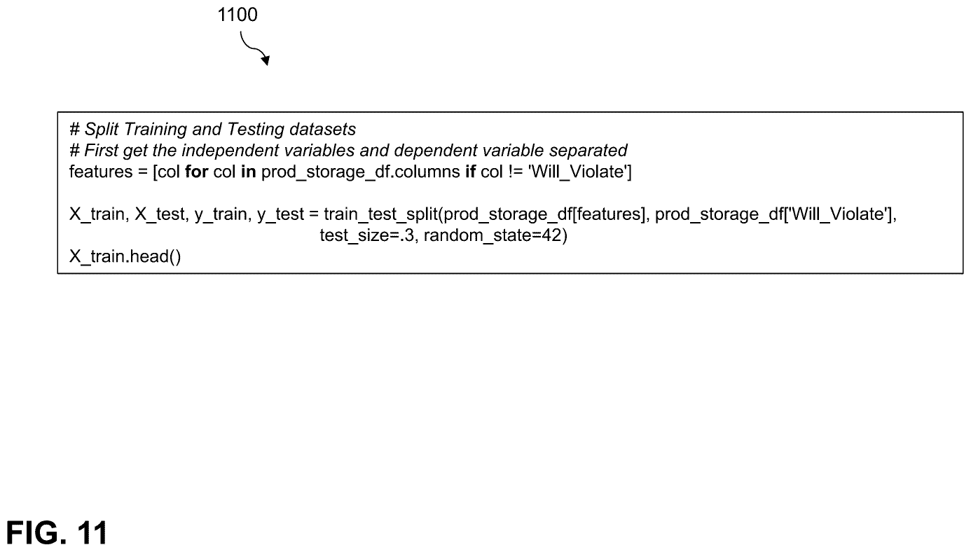

FIG. 11 shows example pseudocode for splitting training and testing datasets in an illustrative embodiment. In this embodiment, example pseudocode 1100 is executed by or under the control of at least one processing system and/or device. For example, the example pseudocode 1100 may be viewed as comprising a portion of a software implementation of at least part of automated device storage management system 105 of the FIG. 1 embodiment.

The example pseudocode 1100 illustrates splitting preprocessed data into training and testing sets using a train_test_split function of a ScikitLearn library. In an example embodiment, the training set will contain approximately 70% of the observations while the testing set will contain approximately 30% of the observations.

It is to be appreciated that this particular example pseudocode shows just one example implementation of splitting training and testing datasets, and alternative implementations can be used in other embodiments.

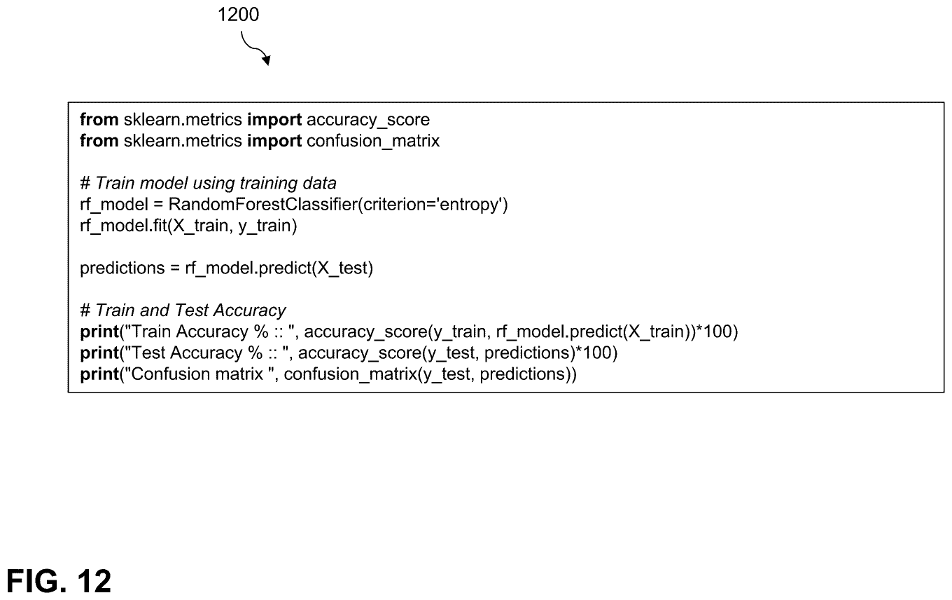

FIG. 12 shows example pseudocode for training and evaluating a random forest classifier model in an illustrative embodiment. In this embodiment, example pseudocode 1200 is executed by or under the control of at least one processing system and/or device. For example, the example pseudocode 1200 may be viewed as comprising a portion of a software implementation of at least part of automated device storage management system 105 of the FIG. 1 embodiment.

The example pseudocode 1200 illustrates implementing a random forest classifier model using a ScikitLearn library with the criterion hyperparameter set as “entropy.” The model is trained using the training dataset(s), as detailed in connection with FIG. 11, using both independent variables (X_train) and the target variable (y_train). Once trained, the model is asked to predict by passing at least a portion of the testing data of the independent variable (X_test). The prediction, accuracy and confusion matrix are printed, and hyperparameter tuning can be performed to improve the accuracy of the model (if necessary).

It is to be appreciated that this particular example pseudocode shows just one example implementation of training and evaluating a random forest classifier model, and alternative implementations can be used in other embodiments.

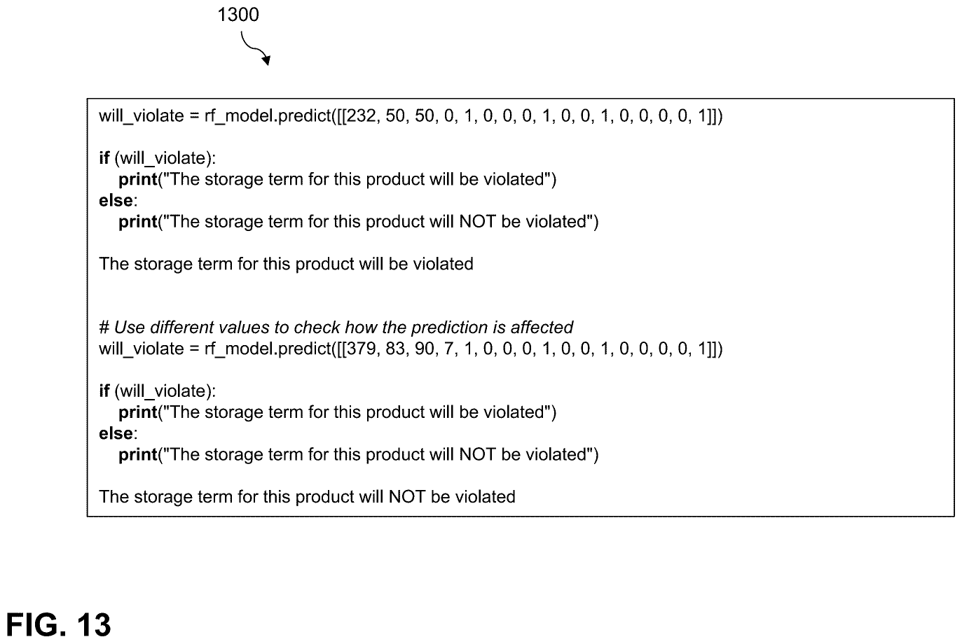

FIG. 13 shows example pseudocode for generating predictions using a trained random forest classifier model in an illustrative embodiment. In this embodiment, example pseudocode 1300 is executed by or under the control of at least one processing system and/or device. For example, the example pseudocode 1300 may be viewed as comprising a portion of a software implementation of at least part of automated device storage management system 105 of the FIG. 1 embodiment.

The example pseudocode 1300 illustrates generating predictions regarding stored devices and whether such storage will violate corresponding storage terms. More particularly, example pseudocode 1300 depicts predictions for two different devices with different storage terms and time left in service, as well as different device quantities and other features. In the case of a term violation prediction, a notification is generated and transmitted to the corresponding user, wherein the notification can request that the user retrieve the device from storage or extend the term limit. As further detailed herein, the notification can be generated using generative artificial intelligence techniques including, for example, a retrieval augmented generation-based (RAG-based) system. In one or more embodiments, related data (e.g., user information, device details, storage information, etc.) can be sent as part of a prompt to an LLM to generate at least a portion of such a notification. Also, the action(s) to be highlighted in the notification (e.g., retrieve device, extend term, etc.) can be encoded data and used as part of the prompt to the LLM.

It is to be appreciated that this particular example pseudocode shows just one example implementation of generating predictions using a trained random forest classifier model, and alternative implementations can be used in other embodiments.

FIG. 14 is a flow diagram of a process for artificial intelligence-based device storage management with machine learning-based processing of data structures in an illustrative embodiment. It is to be understood that this particular process is only an example, and additional or alternative processes can be carried out in other embodiments.

In this embodiment, the process includes steps 1400 through 1406. These steps are assumed to be performed by the automated device storage management system 105 utilizing elements 112, 114 and 116.

Step 1400 includes processing input data into one or more data structures, the input data related to storing at least one device for at least one user. In at least one embodiment, processing input data into one or more data structures includes extracting, from the input data, one or more data features pertaining to one or more of identifying information for the at least one user, identifying information for the at least one device, geographical information related to the at least one user, and temporal information related to at least one device storage request.

Step 1402 includes predicting at least one duration of storage of the at least one device for the at least one user by processing at least portions of the one or more data structures using one or more machine learning techniques. In one or more embodiments, predicting at least one duration of storage of the at least one device for the at least one user includes processing the at least portions of the one or more data structures using at least one multi-output neural network. In such an embodiment, the at least one multi-output neural network includes at least one regressor and at least one classifier.

Step 1404 includes predicting a likelihood of storing the at least one device beyond the at least one predicted duration of storage by processing at least portions of the one or more data structures using the one or more machine learning techniques. In at least one embodiment, predicting a likelihood of storing the at least one device beyond the at least one predicted duration of storage includes processing the at least portions of the one or more data structures using the at least one multi-output neural network.

Step 1406 includes performing one or more automated actions based at least in part on one or more of the at least one predicted duration of storage and the predicted likelihood of storing the at least one device beyond the at least one predicted duration of storage. In one or more embodiments, performing one or more automated actions includes generating and transmitting, to at least one system associated with the at least one user, one or more notifications pertaining to the storage of the at least one device. In such an embodiment, generating the one or more notifications includes using one or more generative artificial intelligence techniques to generate notification content related to a need for action by the at least one user with respect to the storage of the at least one device. Transmitting the one or more notifications to at least one system associated with the at least one user can include, for example, transmitting the notification(s) to one or more device storage systems (e.g., device storage systems 106 in the FIG. 1 embodiment) storing the at least one device for the at least one user, one or more device manufacturing systems (e.g., device manufacturing systems 108 in the FIG. 1 embodiment) manufacturing the at least one device if the predictions are being generated pre-storage (e.g., as part of the sale of the at least one device), and/or one or more device transport systems (e.g., device transport systems 111 in the FIG. 1 embodiment) involved in transporting the at least one device from storage to the at least one user and/or from a device manufacturing system to a device storage system.

Also, in such an embodiment, using one or more generative artificial intelligence techniques to generate notification content related to a need for action by the at least one user with respect to the storage of the at least one device can include using one or more generative artificial intelligence techniques to generate notification content comprising at least one of a request for the at least one user to retrieve the at least one device from storage and a request to propose an updated duration of storage of the at least one device for the at least one user.

Additionally or alternatively, generating the one or more notifications using one or more generative artificial intelligence techniques comprises implementing at least one RAG-based system. Further, in at least one embodiment, performing one or more automated actions can include automatically training at least a portion of the one or more machine learning techniques based at least on feedback related to one or more of the at least one predicted duration of storage and the predicted likelihood of storing the at least one device beyond the at least one predicted duration of storage.

Further, in at least one embodiment, performing one or more automated actions includes using one or more generative artificial intelligence techniques to generate one or more outputs. In such an embodiment, using one or more generative artificial intelligence techniques to generate one or more outputs can include using one or more generative artificial intelligence techniques to generate notification content comprising at least one of a request for the at least one user to retrieve the at least one device from storage and a request to propose an updated duration of storage of the at least one device for the at least one user. Additionally or alternatively, using one or more generative artificial intelligence techniques can include updating at least a portion of the one or more data structures based at least in part on the one or more outputs generated using the one or more generative artificial intelligence techniques.

Accordingly, the particular processing operations and other functionality described in conjunction with the flow diagram of FIG. 14 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to automatically predict a storage duration for a given device for a given user, and automatically predict the likelihood of the given user storing the given device beyond the storage duration. These and other embodiments can effectively overcome problems associated with resource-intensive, error-prone and unpredictable conventional techniques.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

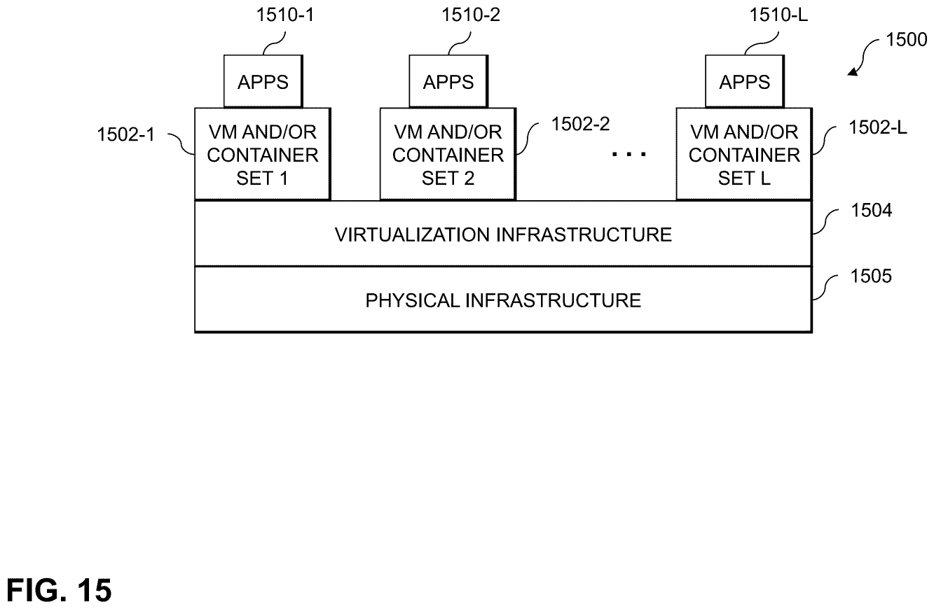

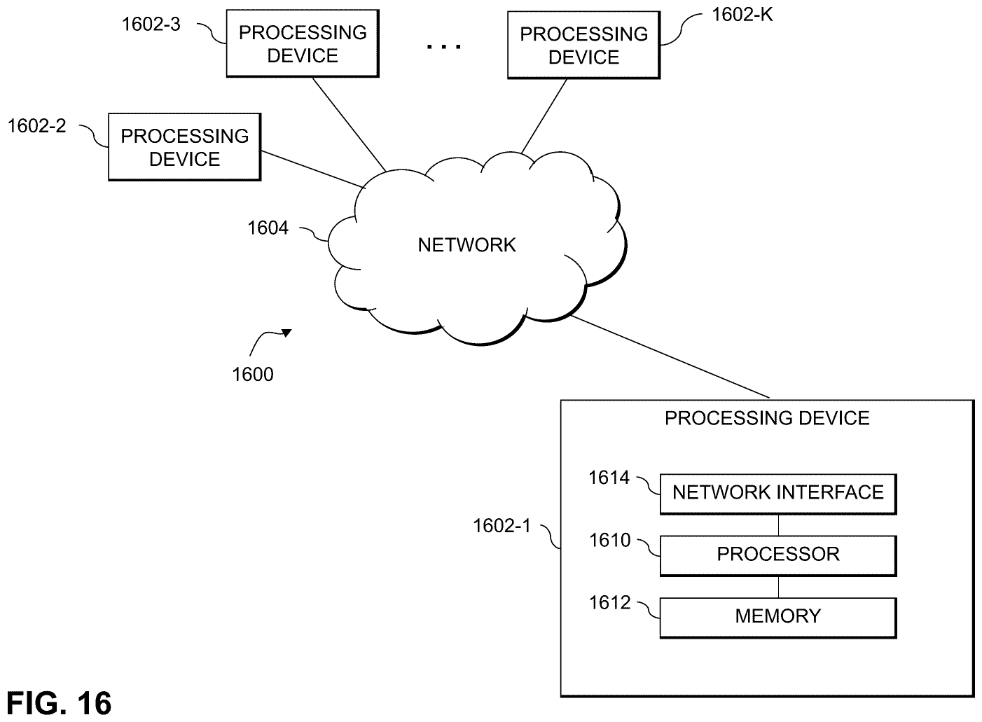

Illustrative embodiments of processing platforms will now be described in greater detail with reference to FIGS. 15 and 16. Although described in the context of system 100, these platforms may also be used to implement at least portions of other information processing systems in other embodiments.

FIG. 15 shows an example processing platform comprising cloud infrastructure 1500. The cloud infrastructure 1500 comprises a combination of physical and virtual processing resources that are utilized to implement at least a portion of the information processing system 100. The cloud infrastructure 1500 comprises multiple virtual machines (VMs) and/or container sets 1502-1, 1502-2, . . . 1502-L implemented using virtualization infrastructure 1504. The virtualization infrastructure 1504 runs on physical infrastructure 1505, and illustratively comprises one or more hypervisors and/or operating system level virtualization infrastructure. The operating system level virtualization infrastructure illustratively comprises kernel control groups of a Linux operating system or other type of operating system.

The cloud infrastructure 1500 further comprises sets of applications 1510-1, 1510-2, . . . 1510-L running on respective ones of the VMs/container sets 1502-1, 1502-2, . . . 1502-L under the control of the virtualization infrastructure 1504. The VMs/container sets 1502 comprise respective VMs, respective sets of one or more containers, or respective sets of one or more containers running in VMs. In some implementations of the FIG. 15 embodiment, the VMs/container sets 1502 comprise respective VMs implemented using virtualization infrastructure 1504 that comprises at least one hypervisor.

A hypervisor platform may be used to implement a hypervisor within the virtualization infrastructure 1504, wherein the hypervisor platform has an associated virtual infrastructure management system. The underlying physical machines comprise one or more information processing platforms that include one or more storage systems.

In other implementations of the FIG. 15 embodiment, the VMs/container sets 1502 comprise respective containers implemented using virtualization infrastructure 1504 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 1500 shown in FIG. 15 may represent at least a portion of one processing platform. Another example of such a processing platform is processing platform 1600 shown in FIG. 16.

The processing platform 1600 in this embodiment comprises a portion of system 100 and includes a plurality of processing devices, denoted 1602-1, 1602-2, 1602-3, . . . 1602-K, which communicate with one another over a network 1604.

The network 1604 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 1602-1 in the processing platform 1600 comprises a processor 1610 coupled to a memory 1612.

The processor 1610 comprises a microprocessor, a CPU, a GPU, a TPU, a microcontroller, an ASIC, a FPGA or other type of processing circuitry, as well as portions or combinations of such circuitry elements.

The memory 1612 comprises RAM, ROM or other types of memory, in any combination. The memory 1612 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1602-1 is network interface circuitry 1614, which is used to interface the processing device with the network 1604 and other system components, and may comprise conventional transceivers.

The other processing devices 1602 of the processing platform 1600 are assumed to be configured in a manner similar to that shown for processing device 1602-1 in the figure.

Again, the particular processing platform 1600 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of an information processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
processing input data into one or more data structures, the input data related to storing at least one device for at least one user;
predicting at least one duration of storage of the at least one device for the at least one user by processing at least portions of the one or more data structures using one or more machine learning techniques;
predicting a likelihood of storing the at least one device beyond the at least one predicted duration of storage by processing at least portions of the one or more data structures using the one or more machine learning techniques; and
performing one or more automated actions based at least in part on one or more of the at least one predicted duration of storage and the predicted likelihood of storing the at least one device beyond the at least one predicted duration of storage;
wherein the method is performed by at least one processing device comprising a processor coupled to a memory.

2. The computer-implemented method of claim 1, wherein predicting at least one duration of storage of the at least one device for the at least one user comprises processing the at least portions of the one or more data structures using at least one multi-output neural network.

3. The computer-implemented method of claim 2, wherein predicting a likelihood of storing the at least one device beyond the at least one predicted duration of storage comprises processing the at least portions of the one or more data structures using the at least one multi-output neural network.

4. The computer-implemented method of claim 2, wherein the at least one multi-output neural network comprises at least one regressor and at least one classifier.

5. The computer-implemented method of claim 1, wherein performing one or more automated actions comprises generating and transmitting, to at least one system associated with the at least one user, one or more notifications pertaining to the storage of the at least one device.

6. The computer-implemented method of claim 1, wherein performing one or more automated actions comprises using one or more generative artificial intelligence techniques to generate one or more outputs.

7. The computer-implemented method of claim 6, wherein using one or more generative artificial intelligence techniques to generate one or more outputs comprises using one or more generative artificial intelligence techniques to generate notification content comprising at least one of a request for the at least one user to retrieve the at least one device from storage and a request to propose an updated duration of storage of the at least one device for the at least one user.

8. The computer-implemented method of claim 6, wherein using one or more generative artificial intelligence techniques comprises updating at least a portion of the one or more data structures based at least in part on the one or more outputs generated using the one or more generative artificial intelligence techniques.

9. The computer-implemented method of claim 1, wherein performing one or more automated actions comprises automatically training at least a portion of the one or more machine learning techniques based at least on feedback related to one or more of the at least one predicted duration of storage and the predicted likelihood of storing the at least one device beyond the at least one predicted duration of storage.

10. The computer-implemented method of claim 1, wherein processing input data into one or more data structures comprises extracting, from the input data, one or more data features pertaining to one or more of identifying information for the at least one user, identifying information for the at least one device, geographical information related to the at least one user, and temporal information related to at least one device storage request.

11. A non-transitory processor-readable storage medium having stored therein program code of one or more software programs, wherein the program code when executed by at least one processing device causes the at least one processing device:
to process input data into one or more data structures, the input data related to storing at least one device for at least one user;
to predict at least one duration of storage of the at least one device for the at least one user by processing at least portions of the one or more data structures using one or more machine learning techniques;
to predict a likelihood of storing the at least one device beyond the at least one predicted duration of storage by processing at least portions of the one or more data structures using the one or more machine learning techniques; and
to perform one or more automated actions based at least in part on one or more of the at least one predicted duration of storage and the predicted likelihood of storing the at least one device beyond the at least one predicted duration of storage.

12. The non-transitory processor-readable storage medium of claim 11, wherein predicting at least one duration of storage of the at least one device for the at least one user comprises processing the at least portions of the one or more data structures using at least one multi-output neural network.

13. The non-transitory processor-readable storage medium of claim 12, wherein predicting a likelihood of storing the at least one device beyond the at least one predicted duration of storage comprises processing the at least portions of the one or more data structures using the at least one multi-output neural network.

14. The non-transitory processor-readable storage medium of claim 11, wherein performing one or more automated actions comprises generating and transmitting, to at least one system associated with the at least one user, one or more notifications pertaining to the storage of the at least one device.

15. The non-transitory processor-readable storage medium of claim 11, wherein performing one or more automated actions comprises using one or more generative artificial intelligence techniques to generate one or more outputs.

16. An apparatus comprising:
at least one processing device comprising a processor coupled to a memory;
the at least one processing device being configured:
to process input data into one or more data structures, the input data related to storing at least one device for at least one user;
to predict at least one duration of storage of the at least one device for the at least one user by processing at least portions of the one or more data structures using one or more machine learning techniques;
to predict a likelihood of storing the at least one device beyond the at least one predicted duration of storage by processing at least portions of the one or more data structures using the one or more machine learning techniques; and
to perform one or more automated actions based at least in part on one or more of the at least one predicted duration of storage and the predicted likelihood of storing the at least one device beyond the at least one predicted duration of storage.

17. The apparatus of claim 16, wherein predicting at least one duration of storage of the at least one device for the at least one user comprises processing the at least portions of the one or more data structures using at least one multi-output neural network.

18. The apparatus of claim 17, wherein predicting a likelihood of storing the at least one device beyond the at least one predicted duration of storage comprises processing the at least portions of the one or more data structures using the at least one multi-output neural network.

19. The apparatus of claim 16, wherein performing one or more automated actions comprises generating and transmitting, to at least one system associated with the at least one user, one or more notifications pertaining to the storage of the at least one device.

20. The apparatus of claim 16, wherein performing one or more automated actions comprises using one or more generative artificial intelligence techniques to generate one or more outputs.
